(19) United States
(12) Patent Application Publication
(10) Pub. No.: US 2006/0102205 A1
(43) Pub. Date: May 18, 2006

(54) Method for reducing contact angle of water on TAC film

(75) Inventors: Yi-Ping Wang, Ping Chen City (TW); Yao-Chung Cheng, Ping Chen City (TW); Ming-Chih Shih, Ping Chen City (TW)

Correspondence Address: BIRCH STEWART KOLASCH & BIRCH, PO BOX 747, FALLS CHURCH, VA, 22040-0747, US

(73) Assignee: Optimax Technology Corporation

(21) Appl. No.: 11/319,654

(22) Filed: Dec. 29, 2005

Related U.S. Application Data
(63) Continuation-in-part of application No. 10/949,188, filed on Sep. 27, 2004.

(30) Foreign Application Priority Data
Feb. 20, 2004 (TW) 93104361

(51) Int. Cl. B08B 3/00

(52) U.S. Cl. 134/26

(57) ABSTRACT

A TAC film pre-processing method for reducing the contact angle of water on the TAC film is described. In this method, the TAC film is sequentially cleaned by a base solution, water and an acid solution. Then, the TAC film is cleaned by an aqueous solution of an alcohol, such as isopropanol. The concentration of the alcohol is preferably about 4-6% by volume.

### CROSS-REFERRENCE TO RELATED APPLICATIONS

This application is a continuation-in-part of U.S. application Ser. No. 10/949,188, filed Sep. 27, 2004, which claims priority to Taiwan application 93104361, filed Feb. 20, 2004, now pending.

### BACKGROUND

1. Field of Invention

The present invention relates to a TAC film pre-processing method. More particularly, the present invention relates to a TAC film pre-processing method for reducing the contact angle of water on a TAC film.

2. Description of Related Art

LCD displays are one of the most rapidly developed display technologies in the world. In the field of computer industry, computers having LCD displays occupy a very large market share. Moreover, in the market of home televisions, the ratio of televisions with LCD displays (LCDTV) is growing rapidly. Therefore, LCD displays will play a very important role in the future.

An LCD display includes, for example, a back light module, polarizers, a liquid crystal layer and color filters. A polarizer allows a light that is linearly polarized in a specific direction to pass. When the LCD display is controlled by an external voltage, the LCD display is capable of generating a white mode and a black mode. Thus, the LCD display can be controlled to show images.

Therefore, a polarizer plays an important role in an LCD display. Generally speaking, the structure of a polarizer is made by sandwiching a PVA (polyvinyl alcohol) film between two TAC (cellulose tri-acetate) films. The interface between the PVA film and the TAC film is a hydrophilic interface, so that a more hydrophilic TAC film attaches to the PVA film more easily. Therefore, before the TAC film is attached to the PVA film, the TAC film needs to be pre-processed to obtain a smaller contact angle of water, i.e. a better hydrophilic character.

### SUMMARY

It is therefore an aspect of the present invention to provide a TAC film pre-processing method that is capable of reducing the contact angle of water on a TAC film.

It is another aspect of the present invention to provide a TAC film pre-processing method for reducing the contact angle of water on a TAC film, which method is simple, fast, and greatly reduces the contact angle.

It is still another aspect of the present invention to provide a TAC film pre-processing method for reducing the contact angle of water on a TAC film, which method is cheap.

In accordance with the foregoing and other aspects of the present invention, a TAC film pre-processing method for reducing the contact angle of water on a TAC film is provided. The method includes the following steps. The TAC film is sequentially cleaned by a base solution, water, and an acid solution. Then, the TAC film is cleaned by an aqueous solution of an alcohol without arising any solvolysis reaction of the TAC film.

According to a preferred embodiment of this invention, the concentration of the alcohol is preferably about 2-100% by volume, and more preferably 4-6% by volume. The alcohol is, for example, methanol, ethanol, or propanol, and preferably isopropanol (IPA).

The invention has at least the following advantages. The TAC film pre-processing method can effectively reduce the contact angle of water on the TAC film. The method is simple, fast and cheap, and is achieved by adding an alcohol to the second rinse tank.

It is to be understood that both the foregoing general description and the following detailed description are examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a diagram illustrating the structure of a polarizer;

FIG. 2 is a diagram illustrating a contact angle of water on a TAC film; and

FIG. 3 is a flow chart illustrating an exemplary TAC film pre-processing method.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

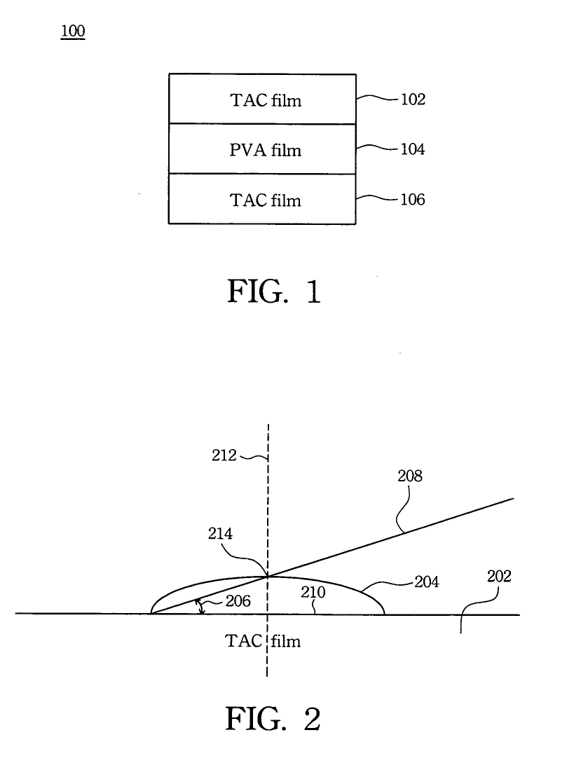

FIG. 1 is a diagram illustrating the structure of a polarizer. With reference to FIG. 1, the polarizer 100 includes a TAC film 102, a PVA film 104, and another TAC film 106. The TAC film 102 and 106 are composed of cellulose tri-acetate. The PVA film 104 is composed of poly vinyl alcohol. The polarizer 100 is used in an LCD display.

Before the TAC film 102, the PVA film 104, and the TAC film 106 are attached together, the TAC film 102 and the TAC film 106 have to be pre-processed, so that the contact angle of water on the TAC film 102 or the TAC film 106 is smaller than 20 degrees. Because the interface between the PVA film 104 and the TAC film 106 is a hydrophilic interface, the contact angle of water on the TAC film 102 or the TAC film 106 should be smaller than 20 degrees for tight cohesion.

FIG. 2 is a diagram illustrating a contact angle of water on a TAC film. A water drop 204 is on the TAC film 202. The contact angle of water on TAC film 202 is defined as twice the angle 206. The angle 206 is between the line 208 and the interface 210. The line 212 is perpendicular to the interface 210 and divides the water drop 204 into two equal parts. Line 212 and line 208 intersect at the point 214 on the surface of the water drop 204.

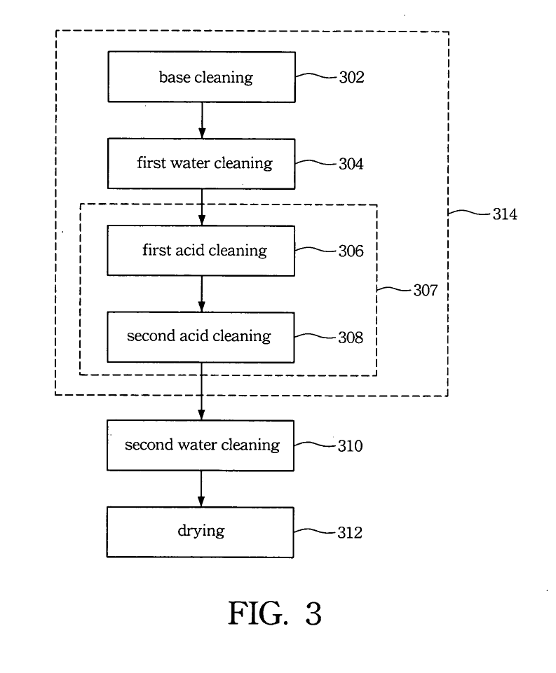

FIG. 3 is a flow chart illustrating an exemplary TAC film pre-processing method. With reference to FIG. 3, the TAC film pre-processing method includes a chemical cleaning process (step 314), a second water cleaning process (step 310) and a drying process (step 312). The chemical cleaning process (step 314) includes, for example, a base cleaning process (step 302), a first water cleaning process (step 304), a first acid cleaning process (step 306), and a second acid cleaning process (step 308). Details of these processes are described as follows.

First, a base cleaning process is performed by immersing the TAC film in a base tank (step 302). The base tank contains KOH and the concentration of KOH is about 1.6 N. The temperature is about 50° C. The process time of the base cleaning is about 100 seconds.

Then, a first water cleaning process is performed by immersing the TAC film in a first rinse tank (step 304). The temperature is about 25° C. The process time of the first water cleaning process is about 4 seconds.

Next, a first acid cleaning process is performed by immersing the TAC film in a first acid tank (step 306). Following that, a second acid cleaning process is performed by immersing the TAC film in a second acid tank (step 308). The first acid cleaning process combined with the second acid cleaning process is called an acid cleaning process (step 307). The first acid tank and the second acid tank both contain, for example, H₂SO₄. The concentration of H₂SO₄ is about 0.1 N in both the first acid tank and the second acid tank. The total acid cleaning process time is about 4 seconds and the temperature is about 25° C.

Then, a second water cleaning process is performed by immersing the TAC film in a second rinse tank (step 310) without solvolysis of the TAC film. An alcohol is added at a predetermined concentration to the second rinse tank. For example, the alcohol can be methanol, ethanol, or propanol. A preferred alcohol is isopropanol (IPA). For example, in the second rinse tank, the predetermined concentration of the alcohol is about 2-100% by volume, and preferably about 4-6% by volume.

Subsequently, a drying process (step 312) is performed by putting the TAC film into an oven. The temperature is about 100° C. and the drying process time is about 10 minutes. Then, a pre-processing process is completed.

An experimental test was held, and the results are listed in Table 1. From the Table 1, it shows that once the IPA was added to the second rinse tank to perform the second water cleaning step 310, the contact angle of water on the TAC film was reduced from 17.6 degrees to smaller than 14 degrees. The contact angle is far smaller than the 20-degree requirement. Therefore, the method mentioned above can effectively reduce the contact angle of water on the TAC film.

TABLE 1

| | | | Water's contact angle |
|---|---|---|---|
| | | | on a TAC film |
| | First water | Second water | (Average of 5 |
| Test | cleaning step 304 | cleaning step 310 | experiments) |
| Test 1 | Water | Water | 17.6 |
| Test 2 | 5% IPA | Water | 17.2 |
| | aqueous solution | | |
| Test 3 | Water | 5% IPA | 13.6 |
| | | aqueous solution | |
| Test 4 | 5% IPA | 5% IPA | 13.2 |
| | aqueous solution | aqueous solution | |

Although the present invention has been described in considerable detail with reference to certain preferred embodiments thereof, other embodiments are possible. Therefore, their spirit and scope of the appended claims should not be limited to the description of the preferred embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A cellulose triacetate (TAC) film pre-processing method for reducing water's contact angle on a TAC film, the TAC pre-processing method comprising:
cleaning the TAC film with a base solution;
cleaning the TAC film with water;
cleaning the TAC film with an acid solution; and
cleaning the TAC film with an aqueous solution of an alcohol without arising any solvolysis reaction to reduce a water's contact angle on the TAC film.

2. The TAC film pre-processing method of claim 1, wherein the alcohol is selected from the group consisting of methanol, ethanol, and propanol.

3. The TAC film pre-processing method of claim 1, wherein the alcohol is isopropanol.

4. The TAC film pre-processing method of claim 1, wherein a concentration of the alcohol is about 2-100% by volume.

5. The TAC film pre-processing method of claim 1, wherein the concentration of the alcohol is about 4-6% by volume.

6. The TAC film pre-processing method of claim 1, wherein the base solution is a KOH solution.

7. The TAC film pre-processing method of claim 1, wherein the acid solution is a H₂SO₄ solution.

8. The TAC film pre-processing method of claim 1, wherein the water's contact angle on the TAC film is smaller than 15 degrees.

9. A cellulose triacetate (TAC) film pre-processing method for reducing water's contact angle on a TAC film, the TAC pre-processing method comprising:
cleaning the TAC film with at least a chemical solution to clean the surfaces of the TAC film; and
cleaning the TAC film with an aqueous solution of an alcohol without arising any solvolysis reaction to reduce a water's contact angle on the TAC film.

10. The TAC film pre-processing method of claim 9, wherein the alcohol is selected from the group consisting of methanol, ethanol, and propanol.

11. The TAC film pre-processing method of claim 9, wherein the alcohol is isopropanol.

12. The TAC film pre-processing method of claim 9, wherein a concentration of the alcohol is about 2-100% by volume.

13. The TAC film pre-processing method of claim 9, wherein the concentration of the alcohol is about 4-6% by volume.

14. The TAC film pre-processing method of claim 9, wherein the chemical solution comprises a base solution.

15. The TAC film pre-processing method of claim 9, wherein the chemical solution comprises an acid solution.

16. The TAC film pre-processing method of claim 9, wherein the water's contact angle on the TAC film is smaller than 15 degrees.
